(19) United States
(12) Patent Application Publication
(10) Pub. No.: US 2026/0310329 A1
(43) Pub. Date: Oct. 8, 2026

(54) SYSTEMS AND METHODS FOR GENERALIZED ARTIFICIAL INTELLIGENT AGENT ARCHITECTURES IN VIRTUAL ENVIRONMENTS

(71) Applicant: Abysius Inc., Minnetonka, MN (US)

(72) Inventor: Kevin Friesth, Fort Dodge, IA (US)

(73) Assignee: Abysius Inc., Minnetonka, MN (US)

(21) Appl. No.: 19/637,631

(22) Filed: Apr. 2, 2026

Related U.S. Application Data
(60) Provisional application No. 63/782,244, filed on Apr. 2, 2025.

(51) Int. Cl. G06F 3/04815; G06N 5/04

(52) U.S. Cl. CPC G06F 3/04815; G06N 5/04

(57) ABSTRACT

Systems and methods provide a framework for the implementation of generalized autonomous intelligent agents in virtual environments within which users can interact with one another and with generalized autonomous intelligent agents in real-time. Through these virtual environments, generalized autonomous intelligent agents can automatically process user interactions to autonomously identify responses and updates to these virtual environments that can be presented to different users within these virtual environments.

### CROSS-REFERENCE TO RELATED APPLICATIONS

The present patent application claims the priority benefit of U.S. Provisional Patent Application Number 63/782,244 filed Apr. 2, 2025, the disclosures of which are incorporated by reference herein.

### FIELD

The present disclosure relates generally to systems and methods for the implementation of generalized autonomous intelligent agents in virtual environments within which users can interact with one another and with generalized autonomous intelligent agents in real-time. Through these virtual environments, generalized autonomous intelligent agents can automatically process user interactions to autonomously identify responses and updates to these virtual environments that can be presented to different users within these virtual environments.

### SUMMARY

Disclosed embodiments provide a framework for the implementation of generalized autonomous intelligent agents in virtual environments within which users can interact with one another and with generalized autonomous intelligent agents in real-time. According to some embodiments, a computer-implemented method is provided. The computer-implemented method comprises monitoring user interactions with one or more assets within a virtual environment. The user interactions are associated with a set of users interacting with the virtual environment through a set of virtual environment interfaces. The computer-implemented method further comprises dynamically processing the user interactions through a generalized autonomous intelligent agent implemented within the virtual environment. The computer-implemented method further comprises identifying one or more domains associated with the user interactions. The computer-implemented method further comprises transmitting the user interactions to a set of domain-specific artificial intelligence models associated with the one or more domains. When the user interactions are received by the set of domain-specific artificial intelligence models, the set of domain-specific artificial intelligence models collaboratively process the user interactions according to the one or more domains to generate a set of proposed modifications to the one or more assets. The computer-implemented method further comprises evaluating the set of proposed modifications according to user characteristics associated with the set of users to generate one or more tailored modifications to the one or more assets. The computer-implemented method further comprises dynamically updating the one or more assets according to the one or more tailored modifications. When the one or more assets are updated, the set of virtual environment interfaces is dynamically updated to present the one or more tailored modifications. The computer-implemented method further comprises updating the generalized autonomous intelligent agent and the set of domain-specific artificial intelligence models according to new user interactions with the updated one or more assets through the set of virtual environment interfaces.

In some embodiments, the one or more tailored modifications correspond to individual user characteristics associated with each user of the set of users. Further, the one or more tailored modifications are presented to each user of the set of users according to the individual user characteristics associated with each user.

In some embodiments, the user interactions further include user communications with the generalized autonomous intelligent agent. Further, the user communications are received during ongoing communications sessions between the set of users and the generalized autonomous intelligent agent implemented through the virtual environment.

In some embodiments, the computer-implemented method further comprises identifying one or more new assets based on the user interactions and the set of proposed modifications. The computer-implemented method further comprises dynamically updating the virtual environment to provide the one or more new assets.

In some embodiments, the generalized autonomous intelligent agent is implemented using a learning intelligent distribution agent (LIDA) architecture. Further, the LIDA architecture is implemented to weigh the set of proposed modifications according to the user characteristics in order to generate the one or more tailored modifications.

In some embodiments, the generalized autonomous intelligent agent continuously executes continuous reinforcement learning (CRL) using feature map attention loss (FMAL) to dynamically update the set of domain-specific artificial intelligence models according to the new user interactions.

In some embodiments, the generalized autonomous intelligent agent is dynamically updated through a self-assessment and improvement loop (SAIL). Further, the generalized autonomous intelligent agent implements SAIL to autonomously apply updates according to the new user interactions.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a generalized autonomous intelligent agent implemented in a virtual environment dynamically processes user interactions within the virtual environment to dynamically provide responses and updates to the virtual environment in accordance with at least one embodiment;

FIG. 2 shows an illustrative example of an environment in which a generalized autonomous intelligent agent, through a set of specialized modules, provides tailored responses and updates to a virtual environment in response to user prompts and user interactions with the virtual environment in accordance with at least one embodiment;

FIG. 3 shows an illustrative example of a process for dynamically generating virtual environment interface and asset updates in response to user prompts and user interactions within the virtual environment in accordance with at least one embodiment;

FIG. 4 shows an illustrative example of a process for generating responses and asset modifications according to an assigned domain and in response to user interactions within a virtual environment in accordance with at least one embodiment; and

FIG. 5 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing preferred examples of embodiments. It is understood that various changes can be made in the function and arrangement of elements without departing from the spirit and scope as set forth in the appended claims.

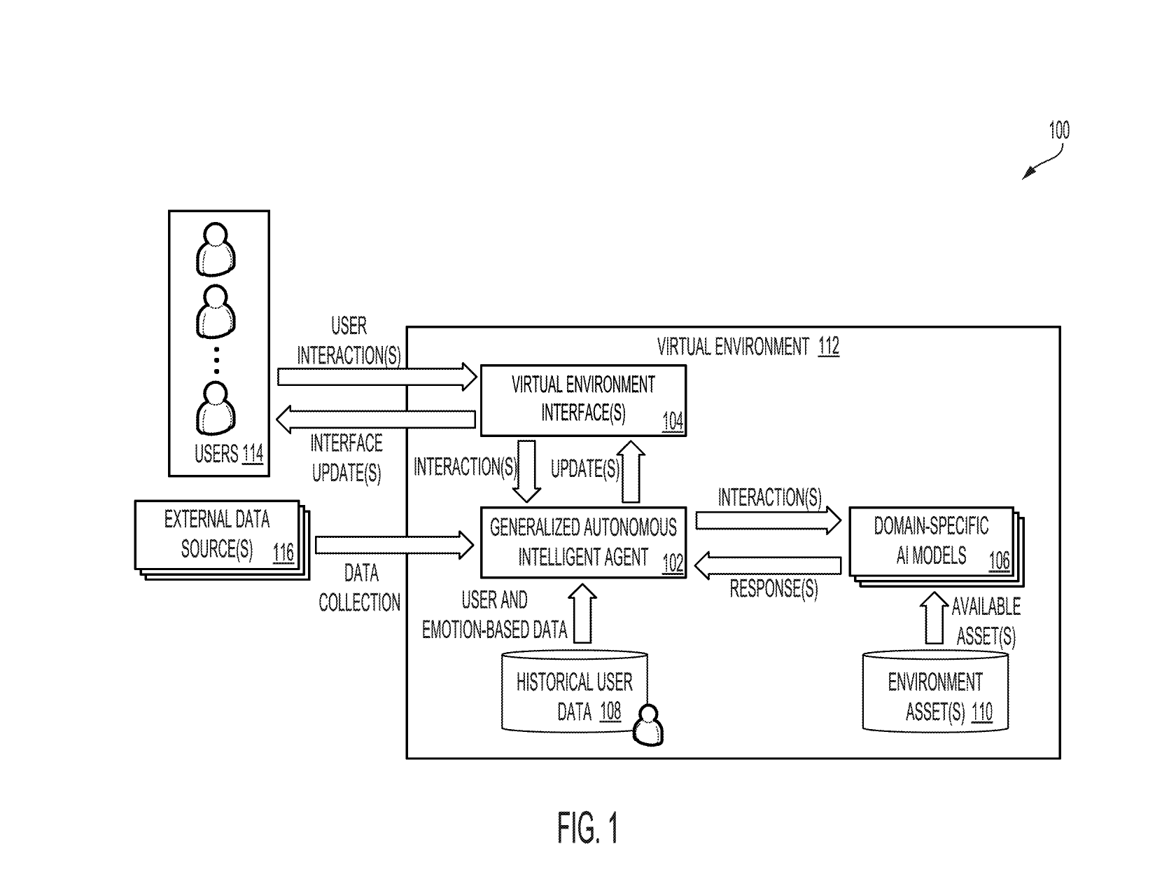

FIG. 1 shows an illustrative example of an environment 100 in which a generalized autonomous intelligent agent 102 implemented in a virtual environment 112 dynamically processes user interactions within the virtual environment 112 to dynamically provide responses and updates to the virtual environment 112 in accordance with at least one embodiment. In the environment 100, a set of users 114 may be virtually present within a virtual environment 112 through one or more virtual environment interfaces 104. Through the virtual environment interfaces 104, users 114 may visualize a multi-domain space through which the users 114 may interact with various elements simultaneously in real time. For instance, within the virtual environment 112 and through the virtual environment interfaces 104, these users 114 may interact with web applications, databases, images, audiovisual recordings, interactive games, chat sessions, and the like.

In an environment, the virtual environment 112 supports virtual reality systems, augmented reality systems, and desktop systems simultaneously through the virtual environment interfaces 104. For example, a user, through an interface (such as a graphical user interface (GUI)) implemented through a browser application or other executable application implemented on a desktop system, may access the virtual environment 112. As another illustrative example, a user may use an augmented reality system, whereby elements of the virtual environment 112 may be presented within the user’s physical environment through use of augmented reality hardware devices (e.g., augmented reality goggles, etc.). The user’s interactions within the augmented reality environment may be mirrored within the virtual environment 112. As yet another example, a user may utilize a virtual reality system, whereby the user may be immersed in the virtual environment 112 from a first-person perspective and, via movements detected by the virtual reality system, move a user avatar corresponding to the user within the virtual environment 112.

In an embodiment, the virtual environment 112 may include a generalized autonomous intelligent agent 102 that can dynamically and in real-time process user interactions with the virtual environment 112 to provide virtual environment updates according to these user interactions. The generalized autonomous intelligent agent 102 is dynamically trained using fuzzy logic with a covariance matrix adaptation evolution strategy (CMA-ES) to derive a set of values corresponding to different hyperparameters or other coefficients that, in combination, are used to derive an output given a sample input. For this set of values, the generalized autonomous intelligent agent 102 may derive a set of weights through random search, grid search, Bayesian optimization, or other hyperparameter optimization mechanism to fine-tune the hyperparameters of the generalized autonomous intelligent agent 102.

The initial training of the generalized autonomous intelligent agent 102 may be performed using human-in-the-loop (HITL) training techniques. For instance, the generalized autonomous intelligent agent 102 may be dynamically trained using a dataset comprising a large corpus of sample virtual environment interactions (e.g., historical virtual environment interactions, hypothetical virtual environment interactions, combinations of historical and hypothetical virtual environment interactions, etc.), sample embeddings corresponding to the sample virtual environment interactions, and sample responses to the sample virtual environment interactions (e.g., historical responses, hypothetical responses, combinations of historical and hypothetical responses, etc.). The generalized autonomous intelligent agent 102 may process the sample virtual environment interactions included in the dataset to generate a set of outputs (e.g., responses or other data outputs) corresponding to these sample virtual environment interactions. Through HITL, an evaluator may compare the set of outputs generated by the generalized autonomous intelligent agent 102 to the sample outputs from the dataset (i.e., expected outputs) to rank the generated outputs and provide corrections to these generated outputs, as necessary.

As illustrated in FIG. 1, the generalized autonomous intelligent agent 102 may leverage a set of domain-specific AI models 106 to generate responses to detected user interactions within the virtual environment 112. These user interactions may include interactions with one or more virtual environment assets (e.g., web applications, databases, images, audiovisual recordings, interactive games, chat sessions, etc.) within the virtual environment 112. In some instances, the user interactions may further include any communications amongst the set of users 114 and the generalized autonomous intelligent agent 102 (i.e., user prompts) within the virtual environment 112. In an embodiment, the set of domain-specific AI models 106 is dynamically trained to provide and implement virtual environment updates according to received prompts and detected user interactions within the virtual environment 112 and that are associated with specific knowledge domains. For instance, the generalized autonomous intelligent agent 102 may use one or more automated machine learning (AutoML) systems to generate a set of different domain-specific AI models that may be trained according to assigned domains and that incorporate different sources of knowledge associated with these domains (e.g., reference texts and manuals, domain-specific databases, training datasets, etc.). To generate this set of domain-specific AI models 106, the one or more AutoML systems may leverage various libraries that correspond to different types of machine learning models. For instance, the one or more AutoML systems may generate the set of domain-specific AI models 106 using recurrent neural networks (RNN), convoluted neural networks (CNN), long short-term memory (LSTM), k-means clustering algorithms, fuzzy c-means (FCM) algorithms, expectation-maximization (EM) algorithms, hierarchical clustering algorithms, density-based spatial clustering of applications with noise (DBSCAN) algorithms, genetic algorithms, backpropagation, reinforcement learning, decision trees, linear classification, anomaly detection, and the like. In an embodiment, each domain-specific AI model of the set of domain-specific AI models 106 is dynamically trained through knowledge distillation, wherein the generalized autonomous intelligent agent 102 can dynamically obtain different sources of knowledge associated with the particular domain for which the domain-specific AI model is to be implemented and transfers these sources of knowledge to the new domain-specific AI model. In some instances, each domain-specific AI model may be trained through Kolmogorov-Arnold networks (KAN) according to the Kolmogorov-Arnold representation theorem. Additionally, or alternatively, certain domain-specific AI models may be trained to form multilayer perceptrons (MLP). Thus, the set of domain-specific AI models 106 may include different domain-specific AI models that are dynamically trained and implemented according to knowledge distillation, KAN, and/or MLP configurations.

In an embodiment, the set of domain-specific AI models 106 is organized according to different clusters or committees that correspond to specific domains or other areas of influence. For instance, the generalized autonomous intelligent agent 102 may define a cluster or committee of domain-specific AI models 106 that, collectively, can process user interactions within the virtual environment 112 and corresponding to aircraft design, incorporating domain-specific AI models corresponding to aerodynamic principles, structural analysis, propulsion and thermal analysis, control systems, and the like. As another illustrative example, the generalized autonomous intelligent agent 102 may define a cluster or committee of domain-specific AI models 106 that, collectively, can process user interactions and prompts corresponding to foreign policy, incorporating domain-specific AI models corresponding to world history, political theory, military doctrines, and the like. To maintain these different clusters or committees, the generalized autonomous intelligent agent 102 may assign specific keywords or disciplines to the different clusters or committees in order to maintain a clear division of labor amongst the different domain-specific AI models 106 implemented by the generalized autonomous intelligent agent 102. Each domain-specific AI model assigned to a particular cluster or committee may be associated with the specific keywords or disciplines such that, when the generalized autonomous intelligent agent 102 selects the particular cluster or committee to review a given user interaction or prompt and generate a response to the user interaction or prompt, the data corresponding to the user interaction or prompt may be provided to each of the domain-specific AI models 106 assigned to the cluster or committee.

To train a domain-specific AI model, the generalized autonomous intelligent agent 102 may use fuzzy logic, along with particle swarm optimization (PSO) and CMA-ES with reinforcement learning, for a particular subdiscipline assigned to the model. In some instances, the generalized autonomous intelligent agent 102 may apply a curriculum learning method according to any sources of knowledge associated with the subdiscipline for which the domain-specific AI model is being trained. For instance, using an initial dataset including sample user interactions and prompts, and expected outputs associated with a particular subdiscipline, the generalized autonomous intelligent agent 102 may evaluate the outputs generated by the domain-specific AI model to determine whether these outputs comport with the expected outputs defined in the dataset. If the generated outputs comport with the expected outputs, the generalized autonomous intelligent agent 102 may dynamically adjust the curriculum (i.e., dataset) to incorporate additional subdiscipline resources that may be more complex in nature and involve advanced concepts related to the subdiscipline. The domain-specific AI model may be evaluated against this new dataset to further enhance the capabilities of the domain-specific AI model in processing prompts related to its subdiscipline.

Application of the curriculum learning method, in an embodiment, includes obtaining myriad training materials from different external data sources 116 for training of the domain-specific AI models 106. For instance, the generalized autonomous intelligent agent 102 may aggregate data from various external data sources 116, including text-based reference materials, audiovisual recordings, images, news articles, scholarly journals, etc. from diverse domains and sources. Further, the generalized autonomous intelligent agent 102 may utilize web scraping, application programming interfaces (APIs), and any accessible datasets (public and/or private) to obtain additional data that may be used to train the domain-specific AI models 106 according to their assigned domains. The generalized autonomous intelligent agent 102 may convert the obtained data into corresponding reference embeddings that may be incorporated into the initial datasets used to train the domain-specific AI models 106. If the generated outputs comport with the expected outputs, the generalized autonomous intelligent agent 102 may dynamically adjust the curriculum (i.e., dataset) to incorporate additional reference embeddings corresponding to more advanced reference materials from the external data sources. The domain-specific AI model may be evaluated against this new dataset, as described above, to further enhance the domain-specific AI model.

In an embodiment, the generalized autonomous intelligent agent 102 is further trained to identify, based on an evaluation of detected user interactions with the virtual environment 112, a cluster or committee of domain-specific AI models to which the detected user interactions may be provided in order to obtain responses to these user interactions (e.g., updates to the virtual environment 112, updates to different virtual environment assets presented within the virtual environment 112, responses to user prompts, etc.). For instance, if the detected user interactions include one or more user prompts, the generalized autonomous intelligent agent 102 may be trained to employ natural language processing (NLP) techniques (including named entity recognition (NER) and dependency parsing) for converting these user prompts into sets of prompt embeddings that may be used to identify the appropriate cluster or committee of domain-specific AI models that may be leveraged to generate responses to these user prompts. For instance, the generalized autonomous intelligent agent 102 may be dynamically trained using a dataset of sample prompts and sample embeddings corresponding to these sample prompts. Using fuzzy logic with CMA-ES, the generalized autonomous intelligent agent 102 may be initialized using a set of coefficients or hyperparameters. The generalized autonomous intelligent agent 102 may process the dataset of sample prompts and corresponding embeddings to generate an output. This output may specify, for each sample prompt included in the dataset, a predicted set of embeddings. This output may be compared to the sample embeddings defined in the dataset for each of the data points (e.g., sample prompts) to identify any inaccuracies or other errors.

In some instances, if the detected user interactions correspond to user manipulations of one or more virtual environment assets presented through the virtual environment interfaces 104, the generalized autonomous intelligent agent 102 may be trained to convert these user manipulations into sets of interaction embeddings that may be used to identify the appropriate cluster or committee of domain-specific AI models that may be leveraged to generate responses to these user interactions. These responses may include the introduction of new virtual environment assets to the virtual environment 112, additional manipulation of existing virtual environment assets, communications that may be exchanged with users, and the like.

If the output of the generalized autonomous intelligent agent 102 does not satisfy one or more criteria, one or more coefficients or hyperparameters of the generalized autonomous intelligent agent 102 may be iteratively updated to generate a new iteration of the generalized autonomous intelligent agent 102. This new iteration of the generalized autonomous intelligent agent 102 may be used to process the aforementioned training dataset, as well as any additional data points or other datasets to generate a new output for each data point in the training dataset. In some instances, an optimization algorithm may be used to iteratively update the one or more coefficients of the set of coefficients associated with the generalized autonomous intelligent agent 102. The new outputs generated by the generalized autonomous intelligent agent 102 may be evaluated to determine whether the new outputs satisfy the one or more criteria. This process of updating the set of coefficients associated with the generalized autonomous intelligent agent 102 according to the one or more criteria may be performed iteratively until an iteration of the generalized autonomous intelligent agent 102 is produced that satisfies the one or more criteria.

Once the generalized autonomous intelligent agent 102 is dynamically trained to convert received user prompts and detected user interactions within the virtual environment 112 into different sets of embeddings using NLP techniques and to use these sets of embeddings to identify which cluster or committee of domain-specific AI models may be leveraged to generate responses to these user prompts and interactions within the virtual environment 112, the generalized autonomous intelligent agent 102 may be integrated with an agent interface within the virtual environment 112 and through which users 114 may interact with the generalized autonomous intelligent agent 102. Through the agent interface, a user may submit a prompt for, or otherwise interact with, the generalized autonomous intelligent agent 102. As noted above, the generalized autonomous intelligent agent 102 implemented within the virtual environment 112 may further continuously monitor the virtual environment 112 to detect any user interactions with the virtual environment 112, other users 114, and any presented virtual environment assets, and that may be indicative of an intent for which different responses may be provided.

In an embodiment, the generalized autonomous intelligent agent 102 maintains a world knowledge graph representation of the different clusters or committees of domain-specific AI models that may be leveraged to generate responses to user prompts and user interactions within the virtual environment 112. This world knowledge graph may be implemented through a data structure that represents the different domain-specific AI models 106 as individual nodes and any corresponding relationships using edges. The world knowledge graph may further denote the different knowledge domains or other areas of influence associated with each of these individual nodes, which may be used to define the different clusters or committees of domain-specific AI models implemented by the generalized autonomous intelligent agent 102. The world knowledge graph, in an embodiment, is further propagated to the individual domain-specific AI models 106 to enhance cross-domain knowledge sharing and emergent behavior as new user prompts and user interactions within the virtual environment 112 are processed. In an embodiment, the world knowledge graph is implemented at a central processing unit (CPU) layer of a generalized autonomous intelligent agent system that implements the virtual environment 112. This may allow for efficient identification a cluster or committee of domain-specific AI models that may be leveraged for generation of one or more responses to a user prompt. By maintaining the world knowledge graph at the CPU layer of the generalized autonomous intelligent agent system, other computational resources of the generalized autonomous intelligent agent system (such as graphics processing units (GPUs), tensor processing units (TPUs), neural processing units (NPUs), language processing units (LPUs), etc.) may be reserved for more extensive tasks, including the training of the generalized autonomous intelligent agent 102 and of the domain-specific AI models 106, the processing of any user prompts according to an identified domain, the generation of responses to user prompts, and any other computationally intensive operation described herein.

In an embodiment, in response to user interactions within the virtual environment 112, the generalized autonomous intelligent agent 102 may process these user interactions to convert the user interactions into a set of interaction embeddings. As noted above, to maintain different clusters or committees of domain-specific AI models corresponding to different knowledge domains, the generalized autonomous intelligent agent 102 may assign specific keywords or disciplines to the different clusters or committees in order to maintain a clear division of labor amongst the different domain-specific AI models 106 implemented by the generalized autonomous intelligent agent 102. The generalized autonomous intelligent agent 102, through the world knowledge graph, may compare the set of interaction embeddings to these specific keywords or disciplines to identify the appropriate cluster or committee of domain-specific AI models that may be leveraged to generate a response to the detected user interactions within the virtual environment 112.

In an embodiment, the set of domain specific AI models 106 and the specialized agents are implemented using computing resources that may be scalable on demand, whereby additional resources may be dynamically implemented in the event of greater resource demand (e.g., data spikes, more stringent bandwidth requirements to limit latency, etc.). In an embodiment, the generalized autonomous intelligent agent 102 dynamically monitors resource utilization of each of the domain specific AI models 106 to determine whether additional domain specific AI model instances are required for generating responses to different user interactions. For instance, if the generalized autonomous intelligent agent 102 determines that a particular domain-specific AI model is failing to satisfy certain performance requirements (e.g., the model is unable to return responses within a threshold period of time, the model is experiencing an input load that exceeds a load threshold, the resources used to implement the model are inoperative or otherwise unavailable for execution of the model, etc.), the generalized autonomous intelligent agent 102 may dynamically provision additional computing resources for instantiation of a new domain-specific AI model that may supplement or replace the particular domain-specific AI model. This new domain-specific AI model may be automatically added to the cluster or committee of domain-specific AI models that the original domain-specific AI model was a member of.

In an embodiment, each cluster or committee of domain-specific AI models can include additional instances of the different domain-specific AI models that comprise the cluster or committee. These additional instances of the different domain-specific AI models may provide redundancy in the event that a particular domain-specific AI model is unable to process new interactions (e.g., the model is failing particular latency thresholds, the model is inoperative or otherwise unavailable, the model is experiencing a spike in demand, etc.). In an embodiment, upon identifying the appropriate cluster or committee of domain-specific AI models that may be leveraged to generate a response to the user interactions, the generalized autonomous intelligent agent 102 may dynamically evaluate the performance of each of the domain-specific AI models that comprise the cluster or committee to identify the particular set of domain-specific AI models to be used for processing the user interactions. This may include selection of particular instances of the different domain-specific AI models according to different performance metrics associated with these instances (e.g., latency, input load, memory utilization, processor utilization, etc.). Based on this evaluation, the generalized autonomous intelligent agent 102 may select the different domain-specific AI model instances within the cluster or committee that may be leveraged for processing of the user interactions.

Once the generalized autonomous intelligent agent 102 has identified the appropriate cluster or committee of domain-specific AI models for processing of the detected user interactions, the generalized autonomous intelligent agent 102 may transmit data corresponding to these detected user interactions to each of the domain-specific AI models associated with the cluster or committee to solicit responses to these user interactions. In an embodiment, the domain-specific AI models associated with a particular cluster or committee may individually process an obtained user prompt to generate a response according to the knowledge domain of the domain-specific AI model. The execution of the different domain-specific AI models of a particular cluster or committee may be performed in parallel such that each domain-specific AI model may simultaneously process detected user interactions with the virtual environment 112 according to its corresponding knowledge domain. The outputs from each of these domain-specific AI models may be circulated within the cluster or committee according to the world knowledge graph to further refine these outputs and/or leverage these outputs to converge towards a finalized response to the detected user interactions. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains. Each domain-specific AI model may also monitor the performance of any downstream domain-specific AI model instances to select the appropriate domain-specific AI model instances to which an output may be provided for further processing.

In an embodiment, the domain-specific AI models 106 associated with a particular domain-specific AI model cluster or committee can query an environment assets datastore 110 to identify any available virtual environment assets that may be implemented in response to the detected user interactions. The environment assets datastore 110 may maintain different virtual environment assets that may be available to the different users 114 associated with the virtual environment 112. For example, the generalized autonomous intelligent agent 102 may implement a set of rules and standards that may be applicable to different users according to their respective roles and that may be used to determine what virtual environment assets these users may be authorized to access and interact with. For instance, when a user interacts with one or more virtual environment assets within a virtual environment 112, the generalized autonomous intelligent agent 102 may assess the user’s role within an organization or other entity to identify the rules and standards that may be applicable to the user (including any interactions with virtual environment assets presented within the virtual environment 112). Based on these rules and standards, the generalized autonomous intelligent agent 102 may identify the virtual environment assets that the user may be authorized to interact with, as well as the particular interactions the user may have with these virtual environment assets. This information may be provided to the domain-specific AI models 106, which may use this information to identify, from the environment assets datastore 110, the different available virtual environment assets that the user is authorized to access and interact with.

In an embodiment, the generalized autonomous intelligent agent 102 is implemented using the learning intelligent distribution agent (LIDA) architecture, which is used to process myriad outputs from different domain-specific AI models 106 to generate a response to user interactions within the virtual environment 112. The generalized autonomous intelligent agent 102, in an embodiment, implements one or more special-purpose modules that may evaluate any responses generated by the one or more domain-specific AI models 106 associated with the selected cluster or committee to generate a comprehensive response to the detected user interactions. For instance, if two or more domain-specific AI models produce conflicting responses to the detected user interactions (e.g., identification of different virtual environment assets that may be presented to the user, conflicting manipulations of one or more virtual environment assets in response to the user interactions, etc.), the generalized autonomous intelligent agent 102, through the one or more special-purpose modules implemented through the LIDA architecture, may dynamically weigh each response according to the intent expressed by the user in their user interactions and the particular knowledge domains of the domain-specific AI models submitting proposed responses.

In an embodiment, the generalized autonomous intelligent agent 102 further determines the emotional states of the users 114 within the virtual environment 112 in order to tailor responses to user interactions that comport with their emotional states at any given time or that otherwise comport with their idiosyncrasies. In an embodiment, the generalized autonomous intelligent agent 102 implements a personal identity network (PIN) algorithm that is trained to construct a coherent narrative from filtered experiences associated with different users over time. Filtered experiences associated with a particular user may be maintained and stored in a historical user datastore 108 based on user interactions with different virtual environment assets within the virtual environment 112 and historical communications sessions between the user and the generalized autonomous intelligent agent 102 over time. For instance, when the user engages the generalized autonomous intelligent agent 102 to obtain responses to user prompts, the generalized autonomous intelligent agent 102 may automatically record any exchanged communications within the historical user datastore 108. Additionally, when the user interacts with other users and with different virtual environment assets within the virtual environment 112, the generalized autonomous intelligent agent 102 may automatically record these interactions within the historical user datastore 108. The historical user datastore 108 may include, for each user of the generalized autonomous intelligent agent 102, an entry corresponding to the user and within which the generalized autonomous intelligent agent 102 may store the communications and virtual environment interactions associated with the user. If the user is accessing the virtual environment 112 and/or the generalized autonomous intelligent agent 102 for the first time, the generalized autonomous intelligent agent 102 may generate a new entry associated with the user within the historical user datastore 108.

In an embodiment, the generalized autonomous intelligent agent 102 is further trained to process user interactions within the virtual environment 112 to determine the user’s current sentiment or emotional state. For example, the generalized autonomous intelligent agent 102, through the virtual environment interface 104, may allow the user to use one or more peripheral devices (e.g., camera, scanner, etc.) implemented on their computing device to engage with the generalized autonomous intelligent agent 102 using real-time audiovisual communications. In an embodiment, the generalized autonomous intelligent agent 102 uses computer vision or other machine learning algorithm/artificial intelligence techniques to dynamically, and in real-time, process the real-time audiovisual communications associated with the user to determine the user’s current sentiment or emotional state. For instance, using computer vision or other machine learning algorithm/artificial intelligence techniques, the generalized autonomous intelligent agent 102 may generate a data representation (e.g., vectors, tensors, etc.) with values representing the user. This data representation of the user may correspond to any detected user mannerisms, eye movements, pupil dilation, body language, and the like.

In an embodiment, the generalized autonomous intelligent agent 102, using computer vision or other machine learning algorithm/artificial intelligence techniques, generates a baseline data representation of the user. This baseline data representation of the user may denote a neutral emotional state or sentiment that represents the user’s natural communication cadence and other idiosyncrasies. Further, this baseline data representation of the user may be reinforced using NLP techniques, which may be used to identify any expressed keywords, phrases, or other terms that may be indicative of the user’s expressed intent and current sentiment or emotional state. As the generalized autonomous intelligent agent 102, using computer vision or other machine learning algorithm/artificial intelligence techniques, processes a data feed comprising audiovisual communications exchanged in real-time, the generalized autonomous intelligent agent 102 may obtain new data representations of the user, with values representing the new biometric information associated with the user. The generalized autonomous intelligent agent 102 may compare these new data representations of the user to the baseline data representation of the user to detect any differences that may denote changes in the user’s emotional state or sentiment. For instance, certain deviations from the baseline data representation may correspond to particular emotional states or sentiments, which may be corroborated or reinforced through evaluation of additional inputs (e.g., text-based inputs, etc.).

In an embodiment, the generalized autonomous intelligent agent 102, based on user interactions within the virtual environment 112 and historical communications exchanged between a user and the generalized autonomous intelligent agent 102, constructs a personal history and emotional model associated with the user. To construct this personal history and emotional model, the generalized autonomous intelligent agent 102, through the PIN algorithm, may perform narrative segmentation of these historical user interactions and communications by dividing these historical user interactions and communications into different segments according to detected themes, events, goals, and the like. Further, through the PIN algorithm, the generalized autonomous intelligent agent 102 may organize these different segments into a chronological structure while highlighting key developments and achievements. The generalized autonomous intelligent agent 102, through the PIN algorithm, may assign weights to each of these segments based on emotional significance such that user interactions identified as having greater emotional significance to the user may be given greater emphasis and addressed. Further, through the PIN algorithm, the generalized autonomous intelligent agent 102 may generate a user profile that may be used to define an emotion-based response strategy (i.e., tailored personality) for responding to user interactions within the virtual environment 112. For instance, the generalized autonomous intelligent agent 102 may leverage this user profile to tailor its responses to user interactions according to any detected user idiosyncrasies, linguistic patterns, dialects, and the like, thereby increasing the likelihood of the user being comfortable communicating with the generalized autonomous intelligent agent 102 over time. In some instances, the generalized autonomous intelligent agent 102 may periodically analyze the user profile and corresponding narrative segmentation and structuring to identify any patterns, biases, or areas for improvement in agent performance. Through this analysis, the generalized autonomous intelligent agent 102 may update the user profile associated with the user and enable the generalized autonomous intelligent agent 102 to improve its tailoring of responses to user interactions within the virtual environment 112 according to any updated user characteristics.

In an embodiment, when the generalized autonomous intelligent agent 102 detects a set of user interactions within the virtual environment 112 (e.g., user interactions with one or more virtual environment assets, user interactions with other users within the virtual environment 112, a user prompt submitted to the generalized autonomous intelligent agent 102 within the virtual environment 112, etc.), the generalized autonomous intelligent agent 102 may process these user interactions to identify any characteristics (e.g., expressed keywords/phrases/terms, manipulations of existing virtual environment assets, introduction of new virtual environment assets, etc.) that may be indicative of the user’s expressed intent. The generalized autonomous intelligent agent 102 may further process these characteristics to determine the user’s current sentiment or emotional state. Based on the user’s current sentiment or emotional state, the generalized autonomous intelligent agent 102 may evaluate the user profile corresponding to the user and the historical user interactions within the virtual environment 112 (as provided in the historical user datastore 108), to determine and tailor a response strategy that may be implemented by the generalized autonomous intelligent agent 102 and any domain-specific AI models 106 identified based on the user’s expressed intent to generate responses to the user interactions, address the user’s current emotional state, and adapt to the user’s communication style and/or other idiosyncrasies. This response strategy may be provided to the domain-specific AI models 106 associated with the selected domain-specific AI model cluster or committee to allow these domain-specific AI models 106 to tailor their responses to user interactions within the virtual environment 112 according to this response strategy.

In an embodiment, prior to providing a response to the detected user interactions within the virtual environment 112, the generalized autonomous intelligent agent 102 evaluates the response to further ensure that the response comports with any applicable ethical rules or standards, ensuring that the generalized autonomous intelligent agent 102 and the domain-specific AI models 106 are not misused or otherwise do not cause unintended consequences. For instance, the generalized autonomous intelligent agent 102 may perform emotion-informed risk assessment to consider emotional aspects when evaluating risks and potential outcomes from providing the generated response to the user. For instance, a given response may present possible ethical dilemmas whereby, based on the user profile, the generalized autonomous intelligent agent 102 may determine that providing the generated response could result in possible self-harm or other forms of harm (e.g., harm or violence to others, violation of applicable laws and regulations, violation of workplace policies, etc.). Accordingly, the generalized autonomous intelligent agent 102 may modify the response to remove any information or other data that may be problematic, thereby addressing the ethical dilemma detected by the autonomous ethical oversight module. As another illustrative example, if the response includes introduction of one or more virtual environment assets that the user is not authorized to access (as determined based on applicable rules and standards associated with the user), the generalized autonomous intelligent agent 102 may modify the response to prevent introduction of these one or more virtual environment assets into the virtual environment 112.

In some instances, the generalized autonomous intelligent agent 102 may further determine whether the given response would present possible ethical dilemmas for other users present within the virtual environment 112. For example, while the user associated with the detected interactions may be authorized to access one or more virtual environment resources that are to be presented in response to these detected interactions, the generalized autonomous intelligent agent 102 may determine that one or more other users within the virtual environment 112 are not authorized to access these virtual environment resources. Accordingly, the generalized autonomous intelligent agent 102 may modify the response such that the one or more virtual environment resources are only visible to and accessible by the user. The response may be implemented such that the virtual environment interface associated with the user is updated to allow user visibility and interaction with the identified virtual environment assets. Further, the response may be implemented such that the virtual environment interfaces associated with the users not authorized to access these identified virtual environment assets are not updated to provide these identified virtual environment assets.

In an embodiment, the generalized autonomous intelligent agent 102 may continuously execute continuous reinforcement learning (CRL) using feature map attention loss (FMAL) to further reinforce and/or update the generalized autonomous intelligent agent 102 and domain-specific AI models 106. For instance, as users provide feedback with regard to provided responses, the generalized autonomous intelligent agent 102 may determine whether these responses accurately corresponded to the detected user interactions. If a user indicates that a response is unsatisfactory (e.g., the response was incorrect, the response did not comport with the user’s expectations, the response was not responsive to the user interactions, etc.), the generalized autonomous intelligent agent 102 may evaluate this feedback to determine the areas of improvement that should be addressed to improve response accuracy. For example, if the generalized autonomous intelligent agent 102 determines that a particular domain-based AI model has provided an erroneous response according to its domain or area of influence, the generalized autonomous intelligent agent 102 may determine the source of this error and apply the aforementioned curriculum learning method to further train the domain-specific AI model according to its assigned knowledge domain. This process may include identifying additional external data sources 116 from which to obtain additional training materials and enhancing the training dataset used to train the domain-specific AI model by incorporating these additional training materials.

In an embodiment, the generalized autonomous intelligent agent 102 further implements a self-assessment and improvement loop (SAIL) or other feedback loop whereby the generalized autonomous intelligent agent 102 may automatically evaluate its performance, identify areas for improvement, and autonomously apply updates to improve its performance. For instance, using SAIL, the generalized autonomous intelligent agent 102 may evaluate user feedback to provided responses and accordingly annotate these responses in order to refine its capabilities in processing user interactions within the virtual environment 112 and evaluating responses prior to dissemination to users over time. For instance, as feedback is obtained from myriad users 114 over time, the generalized autonomous intelligent agent 102 may identify a need for new domain-specific AI models associated with new knowledge domains, as these new domain-specific AI models may be required to address changing contexts. Accordingly, using SAIL, the generalized autonomous intelligent agent 102 may access the external data sources 116 to obtain additional reference materials (such as those described above) according to the identified knowledge domains to implement and dynamically train these new domain-specific AI models. Thus, as the generalized autonomous intelligent agent 102 and the domain-specific AI models 106 process different user interactions within the virtual environment 112 and associated with different users 114, the generalized autonomous intelligent agent 102 may dynamically retrain and/or reinforce itself and the domain-specific AI models 106 through the aforementioned methodologies.

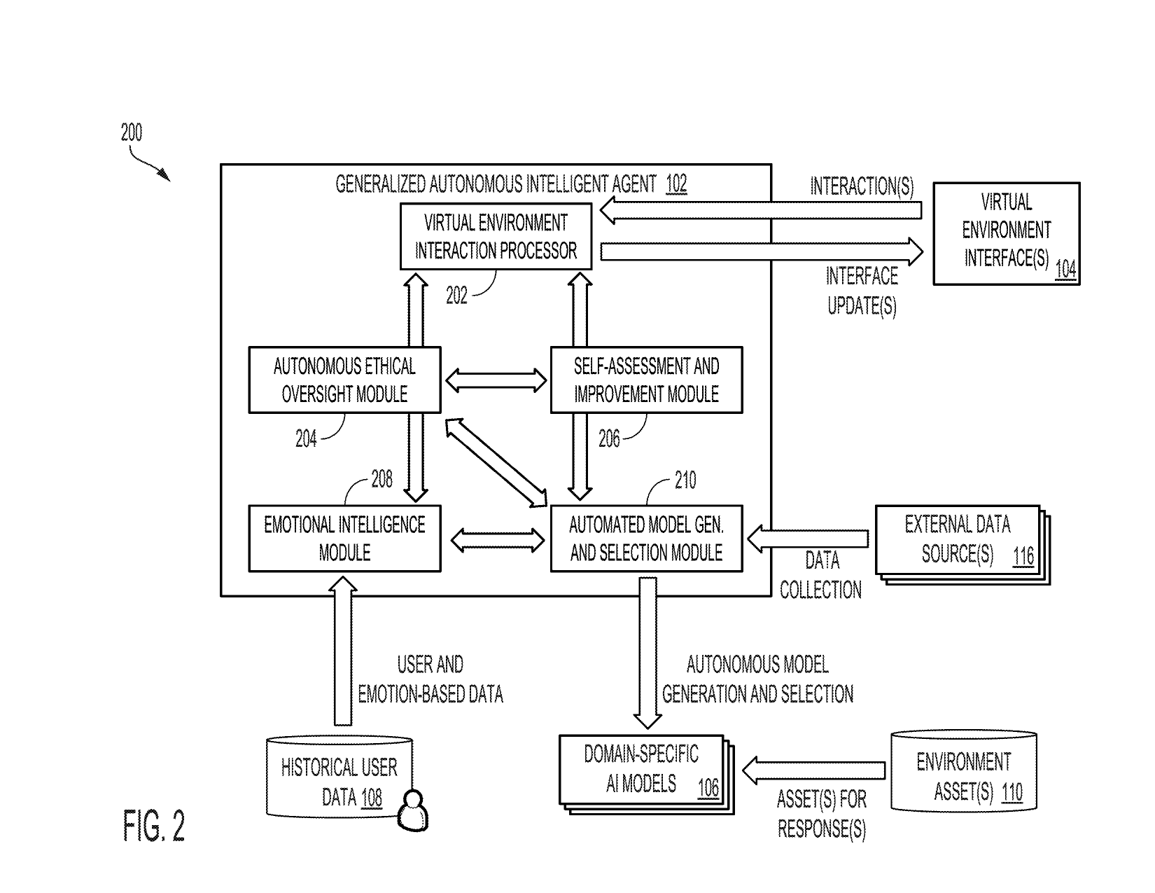

FIG. 2 shows an illustrative example of an environment 200 in which a generalized autonomous intelligent agent 102, through a set of specialized modules 202-210, provides tailored responses and updates to a virtual environment in response to user prompts and user interactions with the virtual environment in accordance with at least one embodiment. In the environment 200, the generalized autonomous intelligent agent 102 may include a virtual environment interaction processor 202 that is configured to process user interactions with a virtual environment, as well as user prompts submitted directly to the generalized autonomous intelligent agent 102 within the virtual environment, and propagate changes to the virtual environment based on these user interactions and prompts. Additionally, if the generalized autonomous intelligent agent 102 communicates with users within the virtual environment, the virtual environment interaction processor 202 may adapt the communication style of the generalized autonomous intelligent agent 102 according to a user’s detected emotional state. For instance, in response to a user prompt, the virtual environment interaction processor 202 may transmit the user prompt to an emotional intelligence module 208 that is trained to determine the emotional state of a user and, accordingly, tailor responses to the user prompt that comport with the user’s emotional state at any given time or that otherwise comport with the user’s identified idiosyncrasies. In an embodiment, the virtual environment interaction processor 202 may monitor the various virtual environment interfaces 104 used to connect users to the virtual environment to detect these user interactions and user prompts.

In an embodiment, the emotional intelligence module 208 implements a PIN algorithm that is trained to construct a coherent narrative from filtered experiences associated with each user accessing the virtual environment over time. As noted above, filtered experiences associated with a user may be maintained and stored in a historical user datastore 108 based on historical communications sessions between the user and the generalized autonomous intelligent agent 102, as well as user interactions with the virtual environment, over time. For instance, when the user engages the generalized autonomous intelligent agent 102 to obtain responses to user prompts, the virtual environment interaction processor 202 may automatically record any exchanged communications within the historical user datastore 108. Additionally, when the user interacts with other users and with different virtual environment assets within the virtual environment 112, the generalized autonomous intelligent agent 102 may automatically record these interactions within the historical user datastore 108. The historical user datastore 108 may include, for each user of the generalized autonomous intelligent agent 102, an entry corresponding to the user and within which the virtual environment interaction processor 202 may store the communications and virtual environment interactions associated with the user. If the user is accessing the virtual environment 112 and/or the generalized autonomous intelligent agent 102 for the first time, the virtual environment interaction processor 202 may generate a new entry associated with the user within the historical user datastore 108.

As noted above, in order to construct a personal history and emotional model for a particular user, the emotional intelligence module 208 may use the PIN algorithm to perform narrative segmentation of communications exchanged between the user and the generalized autonomous intelligent agent 102 and of user interactions within the virtual environment by dividing these communications and user interactions into different segments according to detected themes, events, goals, and the like. Further, the PIN algorithm may organize these different segments into a chronological structure while highlighting key developments and achievements. The PIN algorithm may assign weights to each of these segments based on emotional significance such that user prompts and other user interactions with the virtual environment identified as having greater emotional significance to the user may be given greater emphasis and addressed. Further, through the PIN algorithm, the emotional intelligence module 208 may generate a user profile that may be used to define an emotion-based response strategy (i.e., tailored personality) for responding to user prompts and other user interactions with the virtual environment. For instance, the virtual environment interaction processor 202 may leverage this user profile to tailor its responses to user prompts and other user interactions with the virtual environment according to any detected user idiosyncrasies, linguistic patterns, dialects, and the like, thereby increasing the likelihood of the user being comfortable communicating with the generalized autonomous intelligent agent 102 over time. In some instances, the emotional intelligence module 208 may periodically analyze the user profile and corresponding narrative segmentation and structuring to identify any patterns, biases, or areas for improvement in agent performance. Through this analysis, the emotional intelligence module 208 may update the user profile associated with the user and enable the virtual environment interaction processor 202 to improve its tailoring of responses to user prompts and other user interactions with the virtual environment according to any updated user characteristics.

When the virtual environment interaction processor 202 detects, from a virtual environment interface 104 associated with a user and through which the user may access the virtual environment, a set of user interactions within the virtual environment (e.g., user interactions with one or more virtual environment assets, user interactions with other users within the virtual environment, a user prompt submitted to the generalized autonomous intelligent agent 102 within the virtual environment, etc.), the virtual environment interaction processor 202 may process these user interactions to identify any characteristics (e.g., expressed keywords/phrases/terms, manipulations of existing virtual environment assets, introduction of new virtual environment assets, etc.) that may be indicative of the user’s expressed intent. For example, if a user submits, to the generalized autonomous intelligent agent 102, a user prompt, the virtual environment interaction processor 202 may use NLP techniques to process the newly received user prompt to identify any expressed keywords, phrases, or other terms that may be indicative of the user’s expressed intent. As another illustrative example, if a user communicates with one or more other users within the virtual environment, the virtual environment interaction processor 202 may evaluate these communications using NLP techniques to identify any expressed keywords, phrases, or other terms that may be indicative of the topic of the communications and, accordingly, any intents associated with these users. As yet another illustrative example, if a user interacts with one or more virtual environment assets through their virtual environment interface 104, the virtual environment interaction processor 202 may evaluate these user interactions to identify the user’s likely intent. The virtual environment interaction processor 202 may transmit these identified keywords, phrases, other terms, or user interactions to the emotional intelligence module 208, which may process these identified keywords, phrases, other terms, or user interactions to determine the user’s current sentiment or emotional state.

Based on the user’s current sentiment or emotional state, the emotional intelligence module 208 may evaluate the user profile corresponding to the user and the historical data corresponding to prior user interactions with the virtual environment and communications with the generalized autonomous intelligent agent 102 to determine and tailor a response strategy that may be implemented by the virtual environment interaction processor 202. This response strategy may be implemented by the virtual environment interaction processor 202 to generate responses to user prompts and other user interactions with the virtual environment. For example, if the user submits a user prompt to the generalized autonomous intelligent agent 102, the virtual environment interaction processor 202 may use this response strategy to adapt its response according to the user’s communication style and/or other idiosyncrasies. As another example, if the user interacts with one or more virtual environment assets within the virtual environment, the virtual environment interaction processor 202 may tailor any responses (e.g., modifications to virtual environment assets, introduction of new virtual environment assets, communications regarding the user interactions, etc.) to these user interactions according to the response strategy. Further, based on this evaluation, the emotional intelligence module 208 may provide, to the virtual environment interaction processor 202, an indication as to whether the detected user interactions should be prioritized in order to address the user’s current emotional state.

In an embodiment, in addition to determining the user’s emotional state and developing a response strategy that addresses the user’s emotional state, the virtual environment interaction processor 202, through an autonomous ethical oversight module 204, may evaluate the detected user interactions to determine whether these user interactions, as well as responding to these user interactions, may have ethical and/or moral implications. As noted above, the autonomous ethical oversight module 204 is implemented to evaluate user interactions to ensure that these user interactions comport with any applicable ethical rules or standards, ensuring that the generalized autonomous intelligent agent 102 and the domain-specific AI models 106 are not misused or otherwise do not cause unintended consequences. For example, the autonomous ethical oversight module 204 may implement a set of applicable ethical rules or standards that may specify what intents may be processed by the generalized autonomous intelligent agent 102 as well as any actions that may be performed in the event that a user attempts to perform one or more impermissible actions within the virtual environment. These ethical rules or standards may be specific to certain users or user characteristics. For instance, these ethical rules or standards may correspond to the location of the user (e.g., the ethical rules or standards may correspond to local laws and regulations, etc.). As another example, these ethical rules or standards may correspond to a user’s organization (i.e., employer, etc.). In some instances, the ethical rules or standards may correspond to specific intents and/or user interactions within the virtual environment that may have questionable or harmful ethical and/or moral ramifications (e.g., self-harm, significant potential for harm to others, etc.).

In an embodiment, the autonomous ethical oversight module 204 evaluates in real-time any detected user interactions within the virtual environment (e.g., user prompts to the generalized autonomous intelligent agent 102, manipulations of virtual environment assets, communications with other users within the virtual environment, etc.) to determine whether these user interactions comport with applicable ethical rules and standards. For instance, the virtual environment interaction processor 202, using the aforementioned NLP techniques, may automatically parse a user prompt to identify particular terms and/or phrases that may denote an intent expressed by the user. The virtual environment interaction processor 202 may automatically transmit these identified terms and/or phrases to the autonomous ethical oversight module 204 to determine whether these identified terms and/or phrases and, hence, the user intent, comport with applicable ethical rules and standards. As another illustrative example, the virtual environment interaction processor 202 may transmit data corresponding to the detected user interactions within the virtual environment to the autonomous ethical oversight module 204, which may parse this data to identify the virtual environment assets that the user is interacting with and the type of user interactions. Based on this evaluation and any applicable rules and standards, the autonomous ethical oversight module 204 may determine whether the user is authorized to access these virtual environment assets and perform the detected interactions with these virtual environment assets.

If the autonomous ethical oversight module 204 determines that the determined intent and/or user interactions do not comport with the applicable ethical rules and standards, the autonomous ethical oversight module 204 may automatically determine what action may be taken as a result of the impermissible prompt or user interaction. For instance, the autonomous ethical oversight module 204 may update a common user database implemented by the generalized autonomous intelligent agent 102 to suspend the user, limit the user’s interactions with the generalized autonomous intelligent agent 102 and/or the virtual environment (including any applicable virtual environment assets and the virtual environment interface 104), or otherwise perform any required disciplinary action. In some instances, the autonomous ethical oversight module 204 may communicate with external entities as required to address any violations of the applicable ethical rules and standards (e.g., law enforcement agencies, employers, etc.).

In an embodiment, if the virtual environment interaction processor 202 determines, through the autonomous ethical oversight module 204, that the user prompt or interaction satisfies a corresponding set of applicable ethical rules and standards, the virtual environment interaction processor 202 may transmit data corresponding to the user prompt or interaction to an automated model generation and selection module 210 to generate one or more responses to the user prompt or interaction. The automated model generation and selection module 210 may dynamically generate and maintain domain-specific AI models 106 that are dynamically trained to provide responses to user prompts and interactions associated with specific knowledge distillation techniques. For instance, the automated model generation and selection module 210 implements one or more AutoML systems to generate different domain-specific AI models 106 corresponding to different knowledge domains and that are trained using different resources from external data sources 116. Through these external data sources 116, the automated model generation and selection module 210 may access different sources of knowledge to obtain reference texts and manuals, domain-specific databases, training datasets, etc. that may be used to dynamically train these one or more domain-specific AI models 106.

In an embodiment, to generate this set of domain-specific AI models 106, the automated model generation and selection module 210, through the one or more AutoML systems, may leverage various libraries that correspond to different types of machine learning models. For instance, the one or more AutoML systems may generate the set of domain-specific AI models 106 using RNNs, CNNs, LSTM, k-means clustering algorithms, FCM algorithms, EM algorithms, hierarchical clustering algorithms, DBSCAN algorithms, genetic algorithms, backpropagation, reinforcement learning, decision trees, linear classification, anomaly detection, and the like. As noted above, each domain-specific AI model of the set of domain-specific AI models 106 may be dynamically trained through knowledge distillation, KAN, and/or MLP.

The automated model generation and selection module 210 may organize the set of domain-specific AI models 106 according to different clusters or committees that correspond to specific knowledge domains or other areas of influence. To maintain these different clusters or committees, the automated model generation and selection module 210 may assign specific keywords or disciplines to the different clusters or committees in order to maintain a clear division of labor amongst the different domain-specific AI models 106. Each domain-specific AI model assigned to a particular cluster or committee may be associated with the specific keywords or disciplines such that, when the automated model generation and selection module 210 selects a particular cluster or committee to review a given prompt or user interaction and generate a response to the prompt or user interaction, the prompt or user interaction may be provided to each of the domain-specific AI models 106 assigned to the cluster or committee.

In an embodiment, for each domain-specific AI model, the automated model generation and selection module 210 uses fuzzy logic, along with PSO and CMA-ES with reinforcement learning, for a particular subdiscipline assigned to the model. In some instances, the automated model generation and selection module 210 may apply a curriculum learning method according to any sources of knowledge associated with the subdiscipline for which the domain-specific AI model is being trained. For instance, using an initial dataset including sample user interactions (including user prompts) and expected outputs associated with a particular subdiscipline, the automated model generation and selection module 210 may evaluate the outputs generated by the domain-specific AI model to determine whether these outputs comport with the expected outputs defined in the dataset. If the generated outputs comport with the expected outputs, the automated model generation and selection module 210 may dynamically adjust the curriculum to incorporate additional subdiscipline resources (such as from the external data sources 116) that may be more complex in nature and involve advanced concepts related to the subdiscipline. The domain-specific AI model may be evaluated against this new dataset to further enhance the capabilities of the domain-specific AI model in processing user interactions and prompts related to its subdiscipline.

In an embodiment, the automated model generation and selection module 210 is trained to identify, based on an evaluation of detected user interaction or prompt (as provided by the virtual environment interaction processor 202), the cluster or committee of domain-specific AI models 106 to which a response to the user interaction or prompt may be solicited. For instance, the automated model generation and selection module 210 may be trained to employ NLP techniques (including NER and dependency parsing) for converting received prompts into sets of prompt embeddings that may be used to identify the appropriate cluster or committee of domain-specific AI models 106 that may be leveraged to generate a response to the prompt. As another illustrative example, the automated model generation and selection module 210 may be trained to process data corresponding to a user interaction to identify the virtual environment assets associated with the user interaction, the types or classes of virtual environment assets subject to the user interaction, and any other information that may be used to determine the user’s likely intent in interacting with these virtual environment assets. In some instances, the data corresponding to the user interaction may be converted into a set of interaction embeddings that may be used to identify the appropriate cluster or committee of domain-specific AI models 106 that may be leveraged to generate responses to the user interaction. These responses may include the introduction of new virtual environment assets to the virtual environment, additional manipulation of existing virtual environment assets, communications that may be exchanged with the user with regard to the user interaction, and the like.

As the automated model generation and selection module 210 trains and implements domain-specific AI models and defines different clusters or committees according to different knowledge domains, the automated model generation and selection module 210 may generate or otherwise update a world knowledge graph representation of these different clusters or committees. This world knowledge graph may be leveraged to determine, based on a user interaction or prompt, which cluster or committee of domain-specific AI models may be solicited to provide responses to the user interaction or prompt. As noted above, the world knowledge graph implemented by the automated model generation and selection module 210 may be implemented through a data structure that represents the different domain-specific AI models 106 as individual nodes and any corresponding relationships using edges. The world knowledge graph may further denote the different knowledge domains or other areas of influence associated with each of these individual nodes, which may be used to define the different clusters or committees of domain-specific AI models implemented by the generalized autonomous intelligent agent system. The world knowledge graph, in an embodiment, is further propagated to the individual domain-specific AI models 106 to enhance cross-domain knowledge sharing and emergent behavior as new user interactions and prompts are processed.

In response to a user interaction or prompt, the automated model generation and selection module 210 may convert the user interaction or prompt into a set of embeddings, as described above. The automated model generation and selection module 210 may compare this set of embeddings to the specific keywords or disciplines assigned to each cluster or committee of domain-specific AI models to identify the appropriate cluster or committee of domain-specific AI models that may be leveraged to generate a response to the user interaction or prompt. Once the automated model generation and selection module 210 has identified the appropriate cluster or committee of domain-specific AI models for processing of the user interaction or prompt, the automated model generation and selection module 210 may transmit data corresponding to the user interaction or prompt to each of the domain-specific AI models associated with the cluster or committee to solicit responses to the user interaction or prompt. The different domain-specific AI models 106 within the cluster or committee may collaboratively process the user interaction or prompt according to their individual knowledge domains to generate a cohesive and comprehensive response to the user interaction or prompt. Further, each domain-specific AI model may review and refine any outputs generated by the different domain-specific AI models within a cluster or committee to ensure response accuracy.

In an embodiment, the domain-specific AI models 106 associated with a particular domain-specific AI model cluster or committee can query an environment assets datastore 110 to identify any available virtual environment assets that may be implemented in response to the detected user interaction or prompt. As noted above, the environment assets datastore 110 may maintain different virtual environment assets that may be available to the different users associated with the virtual environment according to any applicable rules and standards. For example, the generalized autonomous intelligent agent 102, through the autonomous ethical oversight module 204, may implement a set of rules and standards that may be applicable to different users according to their respective roles and that may be used to determine what virtual environment assets these users may be authorized to access and interact with. Based on these rules and standards, the autonomous ethical oversight module 204 may identify the virtual environment assets that the user may be authorized to interact with, as well as the particular interactions the user may have with these virtual environment assets. This information may be provided to the domain-specific AI models 106, which may use this information to identify, from the environment assets datastore 110, the different available virtual environment assets that the user is authorized to access and interact with.

As noted above, the execution of the different domain-specific AI models 106 of a particular cluster or committee may be performed in parallel such that each domain-specific AI model may simultaneously process a user interaction or prompt according to its corresponding knowledge domain. The outputs from each of these domain-specific AI models may be circulated within the cluster or committee according to the world knowledge graph to further refine these outputs and/or leverage these outputs to converge towards a finalized response to the user interaction or prompt. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains.

When the automated model generation and selection module 210 obtains a response from the set of domain-specific AI models 106 associated with the selected cluster or committee, the automated model generation and selection module 210 may evaluate the response to determine whether the response may be provided to the user. In an embodiment, the automated model generation and selection module 210 is implemented using the LIDA architecture, which is used to process the outputs from the different domain-specific AI models 106 to generate a cohesive response to the user interaction or prompt. The automated model generation and selection module 210, for instance, may dynamically weigh each response according to the intent expressed by the user in their user prompt and the particular knowledge domains of the domain-specific AI models submitting proposed responses.

In an embodiment, prior to providing a response to user interaction or prompt, the automated model generation and selection module 210, through the autonomous ethical oversight module 204, evaluates the response to ensure that the response comports with any applicable ethical rules or standards, ensuring that the generalized autonomous intelligent agent 102 and the domain-specific AI models 106 are not misused or otherwise do not cause unintended consequences. For instance, the autonomous ethical oversight module 204 may perform emotion-informed risk assessment to consider emotional aspects when evaluating risks and potential outcomes from providing the generated response to the user. As noted above, a given response may present possible ethical dilemmas whereby, based on the user profile, the autonomous ethical oversight module 204 may determine that providing the generated response could result in possible self-harm or other forms of harm (e.g., harm or violence to others, violation of applicable laws and regulations, violation of workplace policies, etc.). Accordingly, the autonomous ethical oversight module 204 may modify the response to remove any information or other data that may be problematic. As another illustrative example, if the response includes introduction of one or more virtual environment assets that the user is not authorized to access (as determined based on applicable rules and standards associated with the user), the autonomous ethical oversight module 204 may modify the response to prevent introduction of these one or more virtual environment assets into the virtual environment. As yet another illustrative example, if the response includes manipulation of one or more virtual environment assets, and the user is not authorized to perform such manipulation of the one or more virtual environment assets, the autonomous ethical oversight module 204 may modify the response to prevent execution of this manipulation. Additionally, prior to providing a response to the user interaction or prompt, the automated model generation and selection module 210, through the emotional intelligence module 208, may modify the response according to the user’s previously identified emotional state and adapt the response according to the user’s communication style and/or other idiosyncrasies, as described above.

Once the automated model generation and selection module 210 has finalized a response that may be propagated to the virtual environment and presented through the virtual environment interface 104, the automated model generation and selection module 210 may provide this finalized response to the virtual environment interaction processor 202 for implementation of the response through the virtual environment. In an embodiment, the virtual environment interaction processor 202 monitors subsequent user communications and interactions within the virtual environment to obtain feedback with regard to provided response. The virtual environment interaction processor 202 may provide this feedback to a self-assessment and improvement module 206, which continuously executes CRL using FMAL to further reinforce and/or update the different modules 202-210 of the generalized autonomous intelligent agent 102 and the domain-specific AI models 106. Returning to an earlier example, as users provide feedback with regard to provided responses, the self-assessment and improvement module 206 may determine whether these responses successfully addressed the corresponding user prompts. If a user indicates that a response is unsatisfactory (e.g., the response was incorrect, the response did not comport with the user’s expectations, the response was not responsive to the user interactions, etc.), the self-assessment and improvement module 206 may evaluate this feedback to determine the areas of improvement that should be addressed to improve response accuracy.

In an embodiment, the self-assessment and improvement module 206 further implements SAIL or other feedback loop whereby the self-assessment and improvement module 206 may automatically evaluate the performance of the other modules of the generalized autonomous intelligent agent 102, identifies areas for improvement, and autonomously applies updates to improve the performance of these modules. For instance, using SAIL, the self-assessment and improvement module 206 may evaluate user feedback to provided responses and accordingly annotate these responses in order to refine its capabilities in processing user interactions within the virtual environment and evaluating responses prior to dissemination to users over time. For instance, as feedback is obtained from myriad users over time, the self-assessment and improvement module 206 may identify a need for new domain-specific AI models associated with new knowledge domains, as these new domain-specific AI models may be required to address changing contexts. Accordingly, using SAIL, the self-assessment and improvement module 206 may access the external data sources 116 to obtain additional reference materials (such as those described above) according to the identified knowledge domains to implement and dynamically train these new domain-specific AI models. Thus, as the generalized autonomous intelligent agent 102 and the domain-specific AI models 106 process different user interactions within the virtual environment and associated with different users, the self-assessment and improvement module 206 may dynamically retrain and/or reinforce itself and the domain-specific AI models 106 through the aforementioned methodologies.

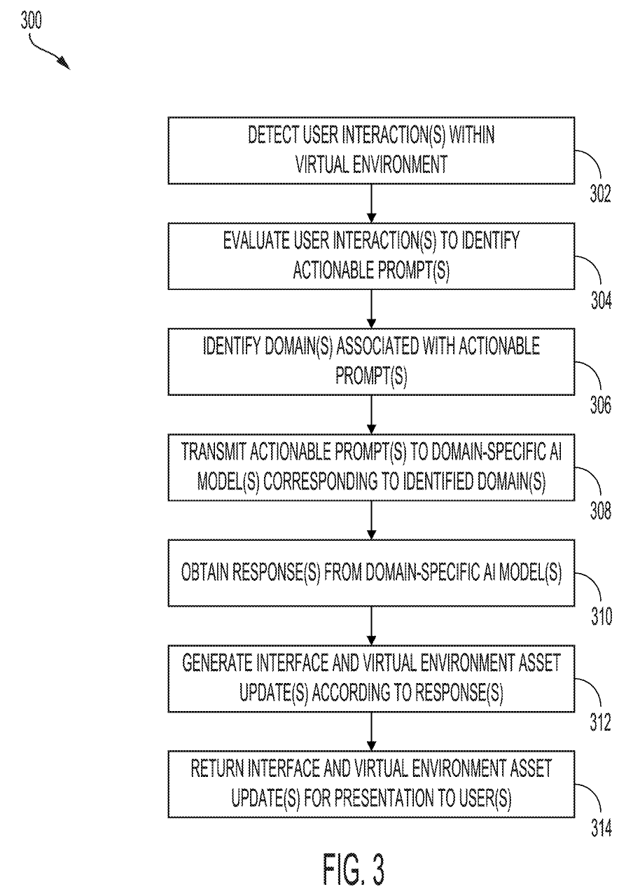

FIG. 3 shows an illustrative example of a process 300 for dynamically generating virtual environment interface and asset updates in response to user prompts and user interactions within the virtual environment in accordance with at least one embodiment. The process 300 may be performed by a generalized autonomous intelligent agent implemented within a virtual environment and that is configured to interact with different users through respective virtual environment interfaces.

At step 302, the generalized autonomous intelligent agent may detect a set of user interactions within a virtual environment. For instance, the generalized autonomous intelligent agent may continuously monitor the virtual environment to detect any user interactions with the virtual environment, other users, and any presented virtual environment assets. In an embodiment, the generalized autonomous intelligent agent implements real-time stream processing, through which the generalized autonomous intelligent may continuously and in real-time monitor and detect any data that is generated within the virtual environment as a result of user interactions with different virtual environment assets, user introduction of new virtual environment assets, user removal of virtual environment assets, user interactions with other users within the virtual environment, user prompts and other communications exchanged with the generalized autonomous intelligent agent within the virtual environment, and the like.

At step 304, the generalized autonomous intelligent agent may evaluate the detected user interactions to identify one or more actionable prompts. As noted above, the generalized autonomous intelligent agent may be trained to process data corresponding to a user interaction to identify the virtual environment assets associated with the user interaction, the types or classes of virtual environment assets subject to the user interaction, and any other information that may be used to determine the user’s likely intent in interacting with these virtual environment assets. In some instances, the data corresponding to the user interaction may be converted into a set of interaction embeddings that may be used to identify comparable actionable prompts for which responses may be generated and provided to users within the virtual environment.

At step 306, the generalized autonomous intelligent agent may identify one or more knowledge domains associated with the identified actionable prompts. For instance, the generalized autonomous intelligent agent may be trained to employ NLP techniques (including NER and dependency parsing) for converting received prompts into sets of prompt embeddings that may be used to identify the knowledge domains associated with the prompts. As another illustrative example, the generalized autonomous intelligent agent may process data corresponding to the identified virtual environment assets associated with the user interaction, the types or classes of virtual environment assets subject to the user interaction, and the like to determine the user’s likely intent in interacting with these virtual environment assets. Based on this intent, the generalized autonomous intelligent agent may identify the one or more knowledge domains that may be relevant to the intent.

At step 308, the generalized autonomous intelligent agent may transmit the actionable prompts to a set of domain-specific AI models corresponding to the identified knowledge domains. As noted above, based on the identified knowledge domains, the generalized autonomous intelligent agent may identify a domain-specific AI model cluster or committee comprising a set of domain-specific AI models that may collectively and collaboratively generate one or more responses to the actionable prompts. In an embodiment, the domain-specific AI models associated with a particular cluster or committee may individually process an obtained prompt to generate a response according to the knowledge domain of the domain-specific AI model. The individual domain-specific AI models may further evaluate the world knowledge graph to provide any outputs to other domain-specific AI models within the cluster or committee that may require these outputs in order to generate additional outputs responsive to the prompt. This process allows the different domain-specific AI models within a cluster or committee to collaboratively process a prompt according to their individual knowledge domains to generate a cohesive and comprehensive response to the prompt. Further, each domain-specific AI model may review and refine any outputs generated by the different domain-specific AI models within a cluster or committee to ensure response accuracy.

At step 310, the generalized autonomous intelligent agent obtains one or more responses from the domain-specific AI models associated with the selected domain-specific AI model cluster or committee. At step 312, the generalized autonomous intelligent agent may generate interface and virtual environment asset updates according to the obtained responses. For instance, the generalized autonomous intelligent agent may evaluate the responses to determine whether the responses may be provided to users within the virtual environment. As noted above, the generalized autonomous intelligent agent may be implemented using the LIDA architecture, which is used to process the outputs from the different domain-specific AI models to generate a cohesive response to a user interaction or prompt. The generalized autonomous intelligent agent, for instance, may dynamically weigh each response according to the intent expressed by the user in through their user interaction or prompt and the particular knowledge domains of the domain-specific AI models submitting proposed responses.

Additionally, the generalized autonomous intelligent agent may evaluate the responses to ensure that the responses comport with any applicable ethical rules or standards, ensuring that the generalized autonomous intelligent agent and the domain-specific AI models are not misused or otherwise do not cause unintended consequences. Based on this evaluation, the generalized autonomous intelligent agent may modify the responses to remove any information or other data that may be problematic. For instance, the generalized autonomous intelligent agent may modify the responses to prevent introduction of one or more virtual environment assets into the virtual environment. As yet another illustrative example, the generalized autonomous intelligent agent may modify the responses to prevent execution of an impermissible manipulation of present virtual environment assets. In some instances, the generalized autonomous intelligent agent may further modify the responses according to a user’s previously identified emotional state and adapt the responses according to the user’s communication style and/or other idiosyncrasies, as described above.

At step 314, the generalized autonomous intelligent agent may return virtual environment interface and virtual environment asset updates for presentation to one or more users within the virtual environment and according to the responses from the domain-specific AI models. For instance, if a response to the actionable prompts includes a manipulation of a virtual environment asset within the virtual environment, the generalized autonomous intelligent agent may perform this manipulation through the virtual environment. In some instances, the generalized autonomous intelligent agent may determine whether the interface and virtual environment asset updates would present possible ethical dilemmas for other users present within the virtual environment. For example, while the user associated with the detected interactions may be authorized to access one or more virtual environment resources that are to be presented in response to these detected interactions, the generalized autonomous intelligent agent may determine that one or more other users within the virtual environment are not authorized to access these virtual environment resources. Accordingly, the generalized autonomous intelligent agent may propagate the updates in a manner such that the one or more virtual environment resources are only visible to and accessible by the user. The updates may be implemented such that the virtual environment interface associated with the user is updated to allow user visibility and interaction with the identified virtual environment assets. Further, the updates may be implemented such that the virtual environment interfaces associated with the users not authorized to access these identified virtual environment assets are not updated to provide these identified virtual environment assets.

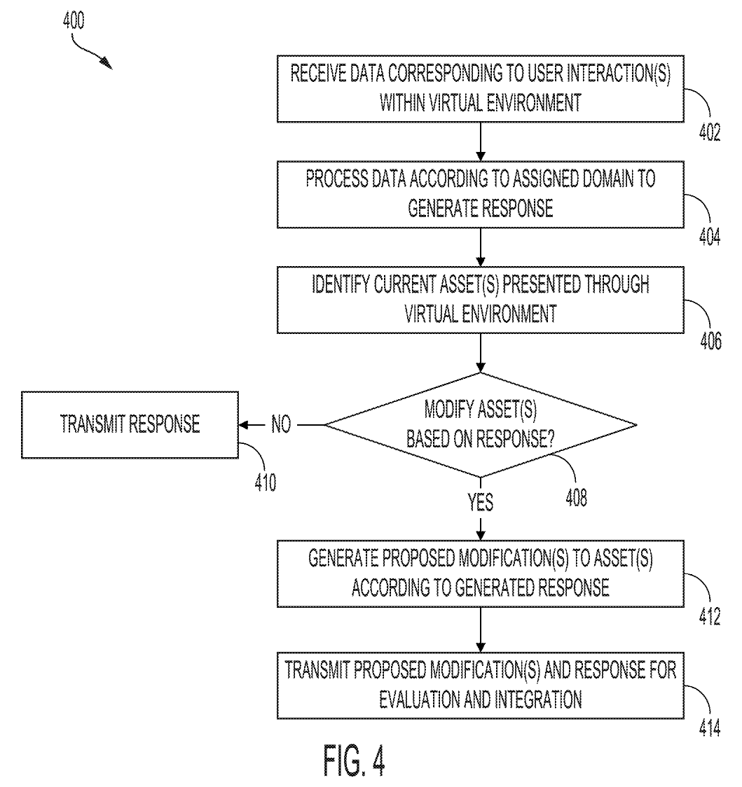

FIG. 4 shows an illustrative example of a process 400 for generating responses and asset modifications according to an assigned domain and in response to user interactions within a virtual environment in accordance with at least one embodiment. The process 400 may be performed by a domain-specific AI model associated with a particular domain-specific AI model cluster or committee.

At step 402, the domain-specific AI model corresponding to a particular knowledge domain may receive data corresponding to user interactions within a virtual environment. As noted above, when the generalized autonomous intelligent agent detects user interactions within a virtual environment (e.g., user interactions with virtual environment assets, user interactions with other users within the virtual environment, user prompts submitted to the generalized autonomous intelligent agent within the virtual environment, etc.), the generalized autonomous intelligent agent may transmit the data corresponding to these user interactions to a set of domain-specific AI models corresponding to identified knowledge domains. For instance, based on the identified knowledge domains, the generalized autonomous intelligent agent may identify a domain-specific AI model cluster or committee comprising a set of domain-specific AI models that may collectively and collaboratively generate one or more responses to the detected user interactions.

At step 404, the domain-specific AI model may process the data corresponding to the detected user interactions according to its assigned knowledge domain in order to generate a response to these user interactions. For example, if the domain-specific AI model is trained to perform structural analyses of different transportation structures, and the data includes a finite element model of an aircraft and a set of corresponding loads, the domain-specific AI model may dynamically process the finite element model and corresponding loads to provide a response that includes outputs of a finite element analysis conducted using the finite element model and corresponding loads (e.g., visual representation of stress/strain distributions, model deformations resulting from application of loads, etc.).

At step 406, the domain-specific AI model may identify the current virtual environment assets that are presented through the virtual environment and, at step 408, determine whether any of these virtual environment assets may need to be modified to provide the response. If the domain-specific AI model determines that the proposed response does not require modification of any existing virtual environment assets, the domain-specific AI model, at step 410, may transmit this proposed response to the other domain-specific AI models associated with the domain-specific AI model cluster or committee for evaluation and integration. As noted above, the execution of the different domain-specific AI models of a particular cluster or committee may be performed in parallel such that each domain-specific AI model may simultaneously process a user interaction or prompt according to its corresponding knowledge domain. The outputs from each of these domain-specific AI models may be circulated within the cluster or committee according to the world knowledge graph to further refine these outputs and/or leverage these outputs to converge towards a finalized response to the user interaction or prompt. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains.

If the domain-specific AI model determines that one or more virtual environment assets require modification in order to implement the response, the domain-specific AI model, at step 412, may generate a set of proposed modifications to these virtual environment assets according to the generated response. Returning to the earlier example whereby the user interaction data includes manipulation of a finite element model to perform a finite element analysis, the domain-specific AI model may determine that a graphical element corresponding to a finite element analysis program executed within the virtual environment is currently being presented to the user within the virtual environment, the domain-specific AI model may determine that the outputs of the finite element analysis conducted by the domain-specific AI model may be presented through this graphical element. Accordingly, the domain-specific AI model may determine that this graphical element may be modified to present these outputs and allow further user interaction to manipulate the finite element model to better visualize these outputs. At step 414, the domain-specific AI model may transmit these proposed asset modifications and the generated response to the other domain-specific AI models assigned to the domain-specific AI model cluster or committee for evaluation and integration.

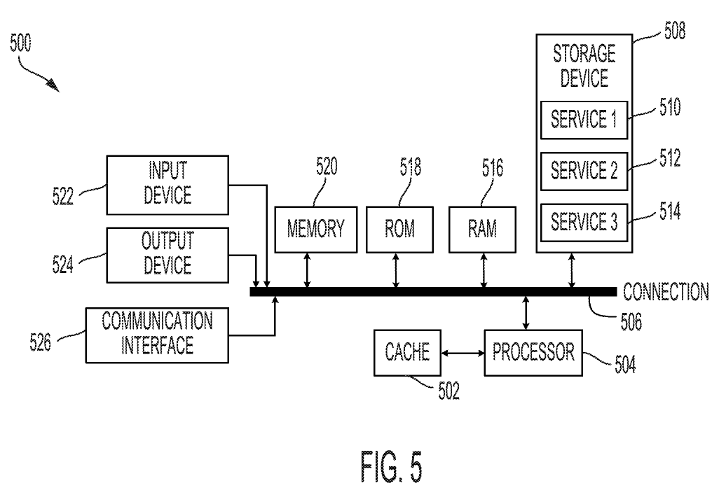

FIG. 5 illustrates a computing system architecture 500 including various components in electrical communication with each other using a connection 506, such as a bus, in accordance with some implementations. Example system architecture 500 includes a processing unit (CPU or processor) 504 and a system connection 506 that couples various system components including the system memory 520, such as ROM 518 and RAM 516, to the processor 504. The system architecture 500 can include a cache 502 of high-speed memory connected directly with, in close proximity to, or integrated as part of the processor 504. The system architecture 500 can copy data from the memory 520 and/or the storage device 508 to the cache 502 for quick access by the processor 504. In this way, the cache can provide a performance boost that avoids processor 504 delays while waiting for data. These and other modules can control or be configured to control the processor 504 to perform various actions.

Other system memory 520 may be available for use as well. The memory 520 can include multiple different types of memory with different performance characteristics. The processor 504 can include any general purpose processor and a hardware or software service, such as service 1510, service 2512, and service 3514 stored in storage device 508, configured to control the processor 504 as well as a special-purpose processor where software instructions are incorporated into the actual processor design. The processor 504 may be a completely self-contained computing system, containing multiple cores or processors, a bus, memory controller, cache, etc. A multi-core processor may be symmetric or asymmetric.

To enable user interaction with the computing system architecture 500, an input device 522 can represent any number of input mechanisms, such as a microphone for speech, a touch-sensitive screen for gesture or graphical input, keyboard, mouse, motion input, speech and so forth. An output device 524 can also be one or more of a number of output mechanisms known to those of skill in the art. In some instances, multimodal systems can enable a user to provide multiple types of input to communicate with the computing system architecture 500. The communications interface 526 can generally govern and manage the user input and system output. There is no restriction on operating on any particular hardware arrangement and therefore the basic features here may easily be substituted for improved hardware or firmware arrangements as they are developed.

Storage device 508 is a non-volatile memory and can be a hard disk or other types of computer readable media which can store data that are accessible by a computer, such as magnetic cassettes, flash memory cards, solid state memory devices, digital versatile disks, cartridges, RAMs 516, ROM 518, and hybrids thereof.

The storage device 508 can include services 510, 512, 514 for controlling the processor 504. Other hardware or software modules are contemplated. The storage device 508 can be connected to the system connection 506. In one aspect, a hardware module that performs a particular function can include the software component stored in a computer-readable medium in connection with the necessary hardware components, such as the processor 504, connection 506, output device 524, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
monitoring user interactions with one or more assets within a virtual environment, wherein the user interactions are associated with a set of users interacting with the virtual environment through a set of virtual environment interfaces;
dynamically processing the user interactions through a generalized autonomous intelligent agent implemented within the virtual environment;
identifying one or more domains associated with the user interactions;
transmitting the user interactions to a set of domain-specific artificial intelligence models associated with the one or more domains, wherein when the user interactions are received by the set of domain-specific artificial intelligence models, the set of domain-specific artificial intelligence models collaboratively process the user interactions according to the one or more domains to generate a set of proposed modifications to the one or more assets;
evaluating the set of proposed modifications according to user characteristics associated with the set of users to generate one or more tailored modifications to the one or more assets;
dynamically updating the one or more assets according to the one or more tailored modifications, wherein when the one or more assets are updated, the set of virtual environment interfaces is dynamically updated to present the one or more tailored modifications; and
updating the generalized autonomous intelligent agent and the set of domain-specific artificial intelligence models according to new user interactions with the updated one or more assets through the set of virtual environment interfaces.

2. The computer-implemented method of claim 1, wherein the one or more tailored modifications correspond to individual user characteristics associated with each user of the set of users, and wherein the one or more tailored modifications are presented to each user of the set of users according to the individual user characteristics associated with each user.

3. The computer-implemented method of claim 1, wherein the user interactions further include user communications with the generalized autonomous intelligent agent, and wherein the user communications are received during ongoing communications sessions between the set of users and the generalized autonomous intelligent agent implemented through the virtual environment.

4. The computer-implemented method of claim 1, further comprising:
identifying one or more new assets based on the user interactions and the set of proposed modifications; and
dynamically updating the virtual environment to provide the one or more new assets.

5. The computer-implemented method of claim 1, wherein the generalized autonomous intelligent agent is implemented using a learning intelligent distribution agent (LIDA) architecture, and wherein the LIDA architecture is implemented to weigh the set of proposed modifications according to the user characteristics in order to generate the one or more tailored modifications.

6. The computer-implemented method of claim 1, wherein the generalized autonomous intelligent agent continuously executes continuous reinforcement learning (CRL) using feature map attention loss (FMAL) to dynamically update the set of domain-specific artificial intelligence models according to the new user interactions.

7. The computer-implemented method of claim 1, wherein the generalized autonomous intelligent agent is dynamically updated through a self-assessment and improvement loop (SAIL), and wherein the generalized autonomous intelligent agent implements SAIL to autonomously apply updates according to the new user interactions.

8. A system, comprising:
one or more processors; and
memory storing thereon instructions that, as a result of being executed by the one or more processors, cause the system to:
monitor user interactions with one or more assets within a virtual environment, wherein the user interactions are associated with a set of users interacting with the virtual environment through a set of virtual environment interfaces;
dynamically process the user interactions through a generalized autonomous intelligent agent implemented within the virtual environment;
identify one or more domains associated with the user interactions;
transmit the user interactions to a set of domain-specific artificial intelligence models associated with the one or more domains, wherein when the user interactions are received by the set of domain-specific artificial intelligence models, the set of domain-specific artificial intelligence models collaboratively process the user interactions according to the one or more domains to generate a set of proposed modifications to the one or more assets;
evaluate the set of proposed modifications according to user characteristics associated with the set of users to generate one or more tailored modifications to the one or more assets;
dynamically update the one or more assets according to the one or more tailored modifications, wherein when the one or more assets are updated, the set of virtual environment interfaces is dynamically updated to present the one or more tailored modifications; and
update the generalized autonomous intelligent agent and the set of domain-specific artificial intelligence models according to new user interactions with the updated one or more assets through the set of virtual environment interfaces.

9. The system of claim 8, wherein the one or more tailored modifications correspond to individual user characteristics associated with each user of the set of users, and wherein the one or more tailored modifications are presented to each user of the set of users according to the individual user characteristics associated with each user.

10. The system of claim 8, wherein the user interactions further include user communications with the generalized autonomous intelligent agent, and wherein the user communications are received during ongoing communications sessions between the set of users and the generalized autonomous intelligent agent implemented through the virtual environment.

11. The system of claim 8, wherein the instructions further cause the system to:
identify one or more new assets based on the user interactions and the set of proposed modifications; and
dynamically update the virtual environment to provide the one or more new assets.

12. The system of claim 8, wherein the generalized autonomous intelligent agent is implemented using a learning intelligent distribution agent (LIDA) architecture, and wherein the LIDA architecture is implemented to weigh the set of proposed modifications according to the user characteristics in order to generate the one or more tailored modifications.

13. The system of claim 8, wherein the generalized autonomous intelligent agent continuously executes continuous reinforcement learning (CRL) using feature map attention loss (FMAL) to dynamically update the set of domain-specific artificial intelligence models according to the new user interactions.

14. The system of claim 8, wherein the generalized autonomous intelligent agent is dynamically updated through a self-assessment and improvement loop (SAIL), and wherein the generalized autonomous intelligent agent implements SAIL to autonomously apply updates according to the new user interactions.

15. A non-transitory computer-readable storage medium storing thereon executable instructions that, as a result of being executed by one or more processors of a computer system, cause the computer system to:
monitor user interactions with one or more assets within a virtual environment, wherein the user interactions are associated with a set of users interacting with the virtual environment through a set of virtual environment interfaces;
dynamically process the user interactions through a generalized autonomous intelligent agent implemented within the virtual environment;
identify one or more domains associated with the user interactions;
transmit the user interactions to a set of domain-specific artificial intelligence models associated with the one or more domains, wherein when the user interactions are received by the set of domain-specific artificial intelligence models, the set of domain-specific artificial intelligence models collaboratively process the user interactions according to the one or more domains to generate a set of proposed modifications to the one or more assets;
evaluate the set of proposed modifications according to user characteristics associated with the set of users to generate one or more tailored modifications to the one or more assets;
dynamically update the one or more assets according to the one or more tailored modifications, wherein when the one or more assets are updated, the set of virtual environment interfaces is dynamically updated to present the one or more tailored modifications; and
update the generalized autonomous intelligent agent and the set of domain-specific artificial intelligence models according to new user interactions with the updated one or more assets through the set of virtual environment interfaces.

16. The non-transitory computer-readable storage medium of claim 15, wherein the one or more tailored modifications correspond to individual user characteristics associated with each user of the set of users, and wherein the one or more tailored modifications are presented to each user of the set of users according to the individual user characteristics associated with each user.

17. The non-transitory computer-readable storage medium of claim 15, wherein the user interactions further include user communications with the generalized autonomous intelligent agent, and wherein the user communications are received during ongoing communications sessions between the set of users and the generalized autonomous intelligent agent implemented through the virtual environment.

18. The non-transitory computer-readable storage medium of claim 15, wherein the executable instructions further cause the computer system to:
identify one or more new assets based on the user interactions and the set of proposed modifications; and
dynamically update the virtual environment to provide the one or more new assets.

19. The non-transitory computer-readable storage medium of claim 15, wherein the generalized autonomous intelligent agent is implemented using a learning intelligent distribution agent (LIDA) architecture, and wherein the LIDA architecture is implemented to weigh the set of proposed modifications according to the user characteristics in order to generate the one or more tailored modifications.

20. The non-transitory computer-readable storage medium of claim 15, wherein the generalized autonomous intelligent agent continuously executes continuous reinforcement learning (CRL) using feature map attention loss (FMAL) to dynamically update the set of domain-specific artificial intelligence models according to the new user interactions.

21. The non-transitory computer-readable storage medium of claim 15, wherein the generalized autonomous intelligent agent is dynamically updated through a self-assessment and improvement loop (SAIL), and wherein the generalized autonomous intelligent agent implements SAIL to autonomously apply updates according to the new user interactions.
